(19) United States
(12) Patent Application Publication
(10) Pub. No.: US 2023/0101491 A1
(43) Pub. Date: Mar. 30, 2023

(54) ELECTRIC MOTOR, STATOR FOR ELECTRIC MOTOR, AND ASSOCIATED MANUFACTURING METHOD

(71) Applicant: VALEO SYSTEMES D'ESSUYAGE, La Verriere (FR)

(72) Inventors: Jose-Luis HERRADA, La Verriere (FR); Mehdi BELHAJ, La Verriere (FR)

(73) Assignee: VALEO SYSTEMES D'ESSUYAGE, La Verriere (FR)

(21) Appl. No.: 17/897,373

(22) Filed: Aug. 29, 2022

(30) Foreign Application Priority Data
Sep. 29, 2021 (FR) 2110268

(51) Int. Cl. H02K 3/28; H02K 3/12; H02K 1/16

(52) U.S. Cl. CPC H02K 3/28; H02K 3/12; H02K 1/165

(57) ABSTRACT

The present invention relates to a stator for an electric motor, comprising a stator body comprising a plurality of teeth extending between an outer part and an inner part of the stator body; a plurality of coils configured to be respectively wound around the plurality of teeth between the outer part and the inner part of the stator body; characterized in that the stator also comprises at least one first connection frame disposed on the inner part of the stator body and configured to provide electrical connections between the coils.

### CROSS-REFERENCE TO RELATED APPLICATIONS

This application claims priority benefit to French Application No. 2110268 filed on Sep. 29, 2021, the disclosure of which is herein incorporated by reference in its entirety.

### TECHNICAL FIELD

The present invention relates to the field of electric motors, and in particular to electric motors intended to equip electric bicycles.

### BACKGROUND OF THE INVENTION

Electric bicycles are increasingly popular due to the ease of travel they afford, while having lower energy consumption, a low environmental impact, and a low cost price.

However, the use of an electric motor in an electric bicycle involves a number of constraints. In particular, high torque and low rotational speed needs to be provided so as to provide effective assistance while at the same time being compatible with the pedaling cadence of the cyclist.

Furthermore, positioning the electric motor on the bicycle, generally in the region of the bottom bracket of the bicycle, involves size constraints in order to allow the electric motor to be installed without compromising other features of the bicycle. In addition, the noise produced by the electric motor also needs to be limited.

In order to at least partially address these constraints, the present invention therefore seeks to provide a smaller electric motor that is able to produce relatively high torque.

### BRIEF SUMMARY OF THE INVENTION

Therefore, the aim of the invention is a stator for an electric motor comprising:

a stator body comprising a plurality of teeth extending between an outer part and an inner part of the stator body;

a plurality of coils configured to be respectively wound around the plurality of teeth between the outer part and the inner part of the stator body;

wherein the stator further comprises:

at least one first connection frame disposed on the inner part of the stator body and configured to provide electrical connections between the coils. The first connection frames are therefore located inside a cylinder, the periphery of which is defined by the coils.

According to one aspect of the present invention, the stator also comprises:

at least one second connection frame disposed on the outer part of the stator body and configured to provide electrical connections between the coils in addition to the at least one first connection frame. The second connection frames are therefore located outside a cylinder, the periphery of which is defined by the coils.

According to another aspect of the present invention, the stator teeth are separate detachable teeth.

According to another aspect of the present invention, the coils are connected as a star arrangement.

According to another aspect of the present invention, the one or more first connection frame(s) and/or second connection frame(s) is/are configured to connect the coils using a standard winding, in which the coils of one phase are connected parallel with each other using a full pitch winding.

According to another aspect of the present invention, the one or more first connection frame(s) and/or second connection frame(s) is/are configured to connect some coils in series using a fractional pitch winding.

According to another aspect of the present invention, the coils are wound by starting winding from the inner part of the stator body. Winding is started at the end of the stator body intended to be oriented towards the inside of the stator in the mounted state of the stator.

According to another aspect of the present invention, the stator comprises a first connection frame configured to connect the coils as a star or triangle arrangement and three second connection frames concentrically extending over the outer part of the stator body in order to connect the coils of one phase to each other, with the second connection frames being separated from each other by non-electrically conductive walls.

According to another aspect of the present invention, the stator comprises a second connection frame configured to connect the windings as a star or triangle arrangement and three first connection frames concentrically extending over the inner part of the stator body in order to connect the coils of one phase to each other, with the first connection frames being separated from each other by non-electrically conductive walls.

According to another aspect of the present invention, the first connection frames are disposed on a module configured to be positioned on the inner part of the stator body.

According to another aspect of the present invention, the non-electrically conductive walls are made of overmolded plastic.

According to another aspect of the present invention, an electrical insulation element is disposed on the stator body of the stator and wherein said electrical insulation element comprises a winding wire retention pad.

According to another aspect of the present invention, the retention pad is a temporary pad configured to be removed when positioning the at least one first connection frame.

According to another aspect of the present invention, the electrical insulation element is configured to accommodate the one or more first and second connection frame(s).

The present invention also relates to an electric motor comprising a stator as described above, wherein said electric motor is a three-phase brushless motor.

According to another aspect of the present invention, the electric motor comprises 10 or 14 poles.

The present invention also relates to a method for manufacturing a stator comprising a stator body comprising a plurality of teeth extending between an outer part and an inner part of the stator body, the method comprising a step of winding a plurality of coils respectively around the plurality of teeth between the outer part and the inner part of the stator body, wherein the winding step is carried out starting from the side of the inner part of the stator, the method also comprising a step of positioning a first connection frame on the inner part of the stator body, said first connection frame being configured to provide electrical connections between the coils.

### BRIEF DESCRIPTION OF THE DRAWINGS

Further features and advantages of the invention will become more clearly apparent upon reading the following description, which is provided by way of a non-limiting illustrative example, and the accompanying drawings, in which:

FIG. 1 shows a schematic perspective view of part of an electric motor according to a first embodiment;

FIG. 2 shows a schematic perspective view of a stator body comprising a plurality of teeth around which coils are wound;

FIG. 3 shows a perspective view of a stator body comprising a plurality of separate teeth around which coils are wound;

FIG. 4 shows an electric diagram of a standard star-shaped winding for a three-phase electric motor comprising 15 coils;

FIG. 5 shows an electric diagram of a fractional star-shaped winding for a three-phase electric motor comprising 18 coils;

FIG. 6 shows a perspective view of a stator comprising connection frames according to a first embodiment;

FIG. 7 shows an exploded view of part of the stator of FIG. 6;

FIG. 8 shows an exploded view of part of the stator of FIG. 6;

FIG. 9 represents a schematic perspective view of part of an electric motor according to a second embodiment;

FIG. 10 shows an exploded view of the connection frames and coils of a stator according to the second embodiment;

FIG. 11 shows a flowchart of the steps of a method for manufacturing a stator according to the first embodiment; and

FIG. 12 shows a flowchart of the steps of a method for manufacturing a stator according to the second embodiment.

### DETAILED DESCRIPTION OF THE INVENTION

In these figures, elements that are identical use the same reference signs.

The following embodiments are examples. Although the description refers to one or more embodiments, this does not necessarily mean that each reference relates to the same embodiment, or that the features apply only to a single embodiment. Simple features of various embodiments also can be combined or interchanged in order to provide other embodiments.

In the present description, some elements or parameters may be indexed, such as, for example, first element or second element and first parameter and second parameter or else first criterion and second criterion, etc. In this case, this is simple indexing for differentiating and denoting elements or parameters or criteria that are similar but not identical. This indexing does not imply a priority of one element, parameter or criterion over another and such denominations may be easily interchanged without departing from the scope of the present description. This indexing also does not imply an order in time, for example, for assessing a particular criterion.

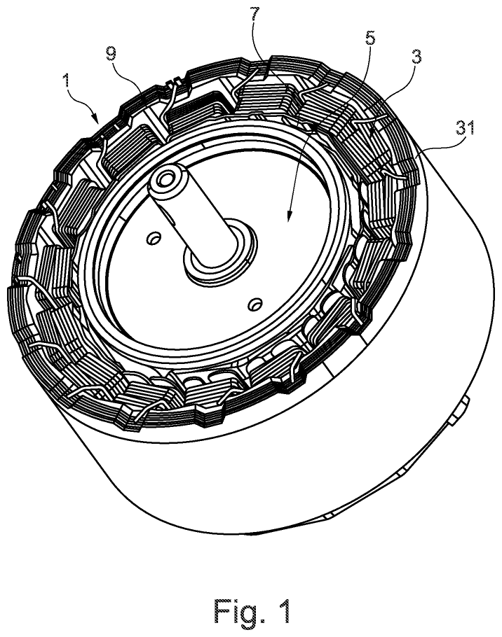

FIG. 1 is a diagram of part of an electric motor 1 comprising a stator 3 and a rotor 5. The electric motor 1 is a brushless electric motor, for example, although the present invention is not limited to this type of electric motor. Such an electric motor 1 is particularly suitable for being fitted to an electric bicycle, but the present invention is not limited to this application.

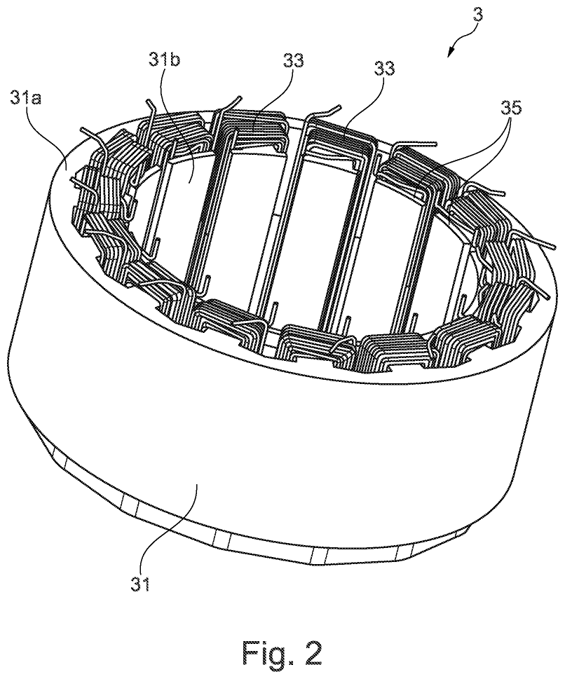

As shown in FIG. 2, the stator 3 comprises a stator body 31 configured to accommodate a plurality of coils 33, fifteen in the example of FIG. 2; however, a different number of coils 33 can be used. The stator body 31 comprises an outer cylindrical part 31a, from which a plurality of teeth 35 extend, fifteen in the case of FIG. 1. The teeth 35 are oriented towards the center of the cylinder and have a T-shaped cross-section configured to retain the windings forming the coils 33. Thus, a coil 33 is formed on each tooth 35 by winding turns of a winding.

The teeth 35 extend between an outer part 31a of the stator 3 formed by the outer cylindrical part 31a and an inner part 31b of the stator 3 formed by the inner end of the teeth 35.

The winding forming the coils 33 generally comprises a plurality of turns that are adjacent and extend between the inner part 31a and the outer part 31b of the stator 3. In addition, several layers of turns can be stacked around the teeth 35.

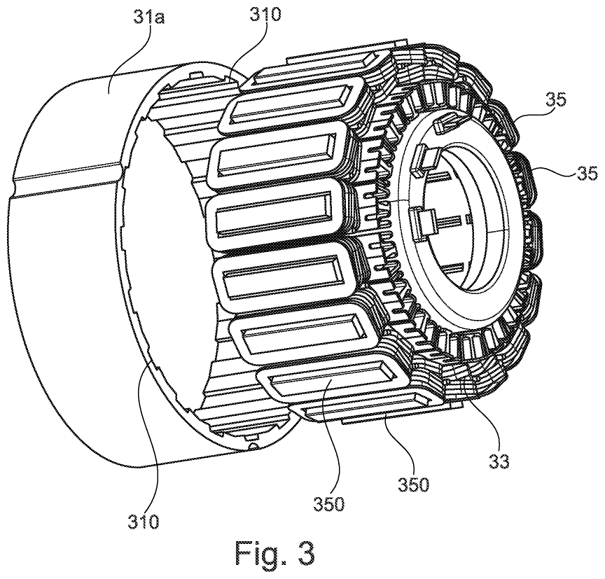

The teeth 35 can be integrally formed with the outer cylindrical part 31a. According to an alternative embodiment, the teeth 35 are separate teeth that are detachable relative to the outer cylindrical part 31a. FIG. 3 shows an example of a stator 3 with separate teeth, in which the cylindrical part 31a comprises a plurality of notches 310 axially extending over the inner side of the cylindrical part 31a. In the case of FIG. 3, the stator 3 comprises fifteen teeth 35, but a stator 3 comprising another number of separate teeth clearly also can be produced. The notches 310 have, for example, a T-shaped or U-shaped cross section. The teeth 35 then comprise a fixing end piece 350 having a cross-sectional shape that matches the notches 310. The fixing end piece 350 is intended to be introduced into a notch 310 of the cylindrical part 31a via a translation movement of the fixing end piece 350 in the notch 310. The teeth 350 are fixed in place as a result of the matching shapes of the fixing end piece 350 and of the notch 310. The use of a stator 3 with separate teeth allows the coils 33 to be wound on the teeth 35 before the teeth 35 are positioned on the cylindrical part 31a, which reduces the space required between the coils 33, as the coils 33 can be closer to each other.

The stator 3 also comprises a plurality of connection frames 7, 9 configured to provide the electrical connections between the coils 33. Various electrical connection configurations can be used to connect the coils 33.

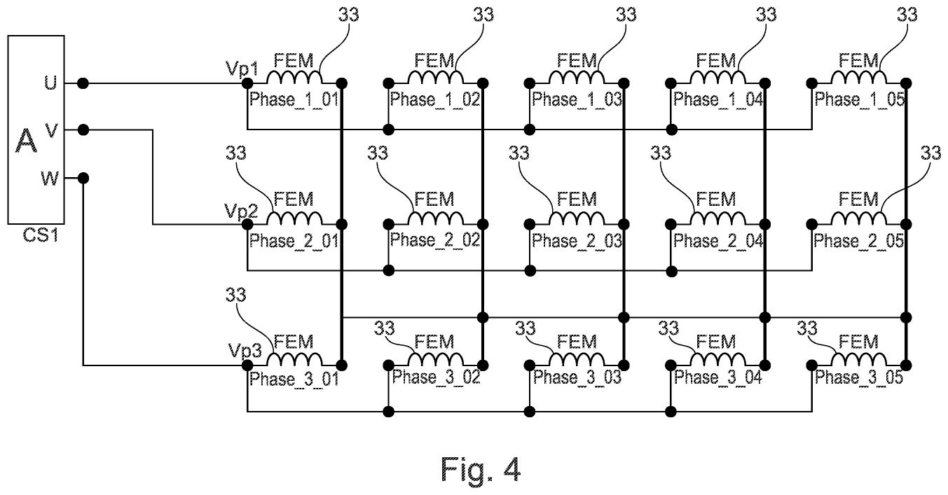

FIG. 4 shows a first electrical configuration, in which the stator 3 comprises 15 coils 33, 3 phases, denoted u, v, w, and in which the coils 33 are connected in a star-shaped configuration using a standard winding, i.e., a winding in which the various coils of a phase u, v, w are disposed in parallel. Such a stator 3 can be used in a 10-pole electric motor 1.

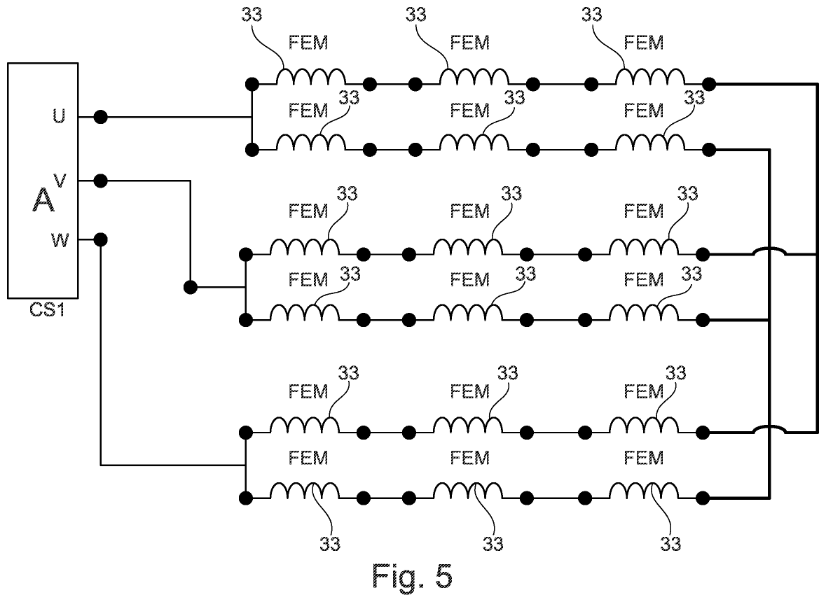

FIG. 5 shows a second electrical configuration, in which the stator 3 comprises 18 coils 33, three phases, denoted u, v, w, and in which the coils 33 are connected in a star-shaped configuration as a fractional winding, i.e., a winding in which some of the coils of a phase u, v, w are disposed in series. In this case, each phase comprises two branches of three coils 33 disposed in series, with the two branches being disposed in parallel. The fractional winding allows a time shift to be produced between the active coils and thus allows a smoother transition when the rotor poles 5 pass in front of the teeth 35 of the stator 3 and thus allows the noise generated by the electric motor 1 to be reduced. Such a stator 3 can be used in an electric motor with 10 or 14 poles, for example, but other numbers of poles can be used.

Such configurations with a large number of coils 33 and poles allow high torque to be obtained, while limiting the size of the electric motor 1 due to the coils being brought closer together through the use of separate teeth.

The invention is not limited to the two winding configurations shown in FIGS. 4 and 5, such that other configurations with a different number of coils 33 in series and/or in parallel and coupled as a star shape or as a triangle shape also can be used.

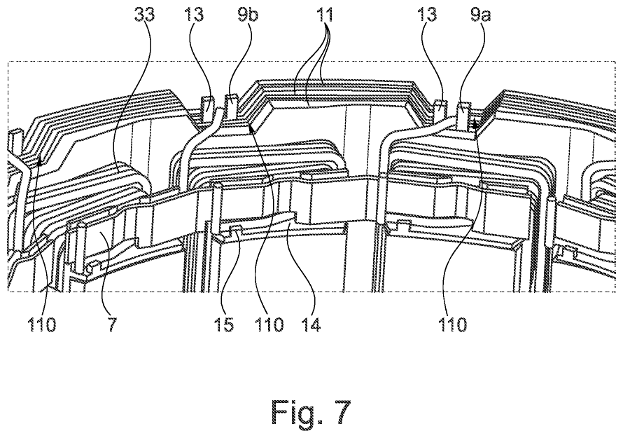

Thus, connection frames 7, 9 connected to the end of the coils 33 are used to connect the various coils 33 according to the selected electrical diagram. These connection frames 7, 9 are disposed on an electrical insulating element 14 (shown in FIG. 7) disposed on the stator body 31. The stator body 31 is made of steel, for example, and the electrical insulating element 14 is made of plastic, for example, and can be overmolded onto the stator body 31.

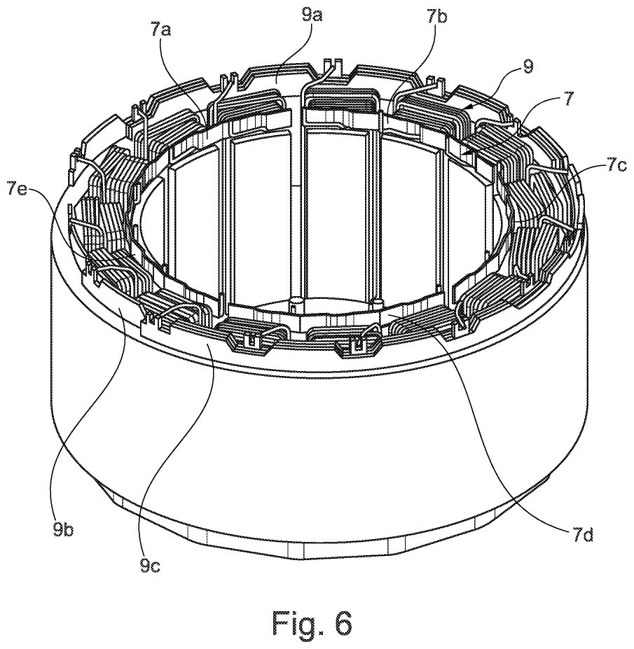

FIGS. 6 to 8 show a first embodiment according to the electrical diagram of FIG. 1 and FIG. 3, in which the stator 3 comprises a first connection frame 7 disposed on the inner part 31b of the stator body 31 and configured to connect a first end of the coils 33 of the various phases u, v, w to each other in order to form the star-shaped connection. The first connection frame 7 comprises five portions, respectively denoted 7a, 7b, 7c, 7d and 7e, each connecting three coils 33 respectively associated with the three phases u, v, w. Preferably, the three coils 33 respectively associated with the three phases u, v, w can be disposed adjacent to each other on the stator body 31, as in FIG. 6.

The stator 3 also comprises second connection frames 9 disposed on the outer part 31a of the stator body 31 and configured to connect the second end of the coils 33 per the electrical diagram of FIG. 4 (parallel connection of the various coils 33 associated with a phase u, v w). The second connection frames 9 are also configured to allow electrical connections to the outside of the stator 3, in particular for powering the various phases u, v, w, for example, via additional connectors disposed on the second connection frames 9. In the example shown in FIG. 5, the stator 3 comprises three second connection frames 9, respectively denoted 9a, 9b and 9c, concentrically disposed on one side of the stator 3 around the coils 33. As can be seen more clearly in FIG. 7, the second connection frames 9 are separated from each other by non-electrically conductive walls 11, also concentrically disposed with the second connection frames 9. These non-electrically conductive walls 11 are made of plastic, for example, and can be overmolded onto the stator body 31 and in particular can be integrally formed with the electrical insulating element 14. In the present example, in order to avoid any short-circuit between the various second connection frames 9, the height of the non-conductive walls 11 is greater than the second connection frames 9 and they locally comprise material recesses 110 in the part thereof that protrudes from the second connection frames 9 in order to allow the connections between the coils 33 and the second connection frames 9. The material recesses 110 of the various non-electrically conductive walls 11 are disposed opposite each other and opposite the coils 33. The number of material recesses 110 corresponds, for example, to the number of coils 33, i.e., fifteen in the example of FIG. 6. In addition, the second connection frames 9 comprise connectors 13 configured to axially project outwards from the stator 3 and to extend opposite the material recesses 110 of the non-electrically conductive walls 11. The second end of the coils 33 is therefore configured to radially extend through the material recesses 110 up to the connector of one of the second connection frames 9 disposed opposite the corresponding coil 33.

The first 7 and second 9 connection frames are thus disposed on a first radial side of the stator body 31 and adjacent to the stator body 31. In addition, the axial height of the first 7 and second 9 connection frames and of the non-electrically conductive walls 11 is limited as much as possible so as to limit the axial dimension of the stator 3. Furthermore, positioning the first connection frame 7 adjacent to the inner part 31b of the stator body 31 and the concentric arrangement of the second connection frames 9 allows the outer diameter of the stator 3 to be limited.

The axial and radial footprint of the stator 3 is therefore reduced compared to the similarly powered electric motors of the prior art.

In addition, as will be better described throughout the remainder of the description, the coils 33 can be wound on the teeth 35 starting from the side of the inner part 31b of the stator body 31, which allows the distance between the first connection frame 7 and the first end of the coil 33 to be limited and also allows the footprint of the coils 33, and thus of the stator 3, to be limited.

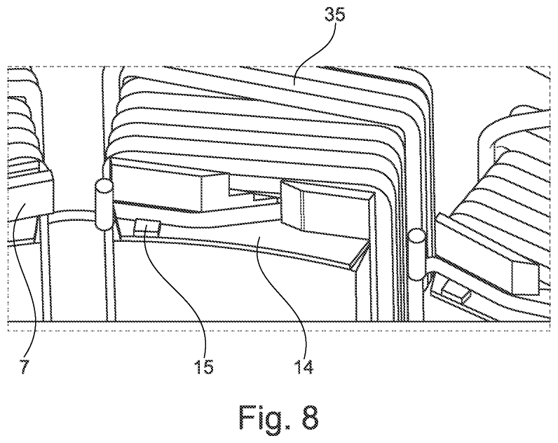

In addition, as shown in FIGS. 7 and 8, a retention pad 15 can be disposed on the inner end of the teeth 35 (located on the side of the inner part 31b of the stator body 31) in order to retain the first end of the wire of the coil 35, particularly when winding the turns in order to form the coil 35. This retention pad 15 can be a temporary pad configured to be removed when connecting the first end of the coil 35 to the first connection frame 7. The retention pad 15 is, for example, disposed on the electrical insulating element 14 and can be integrally formed with said electrical insulating element 14.

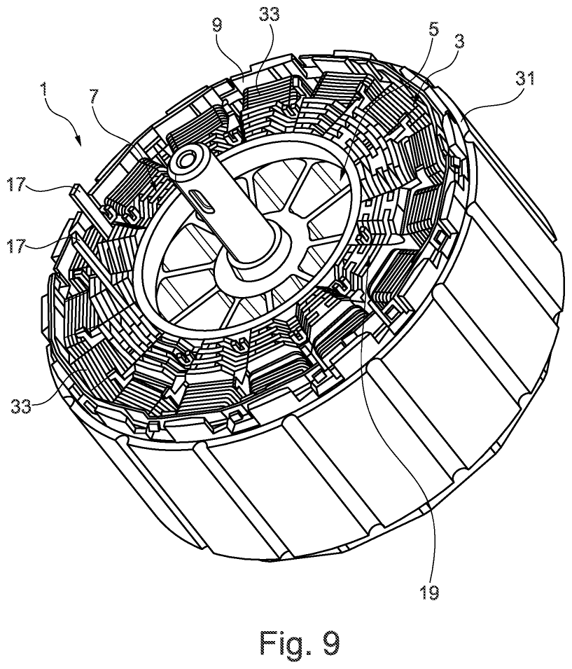

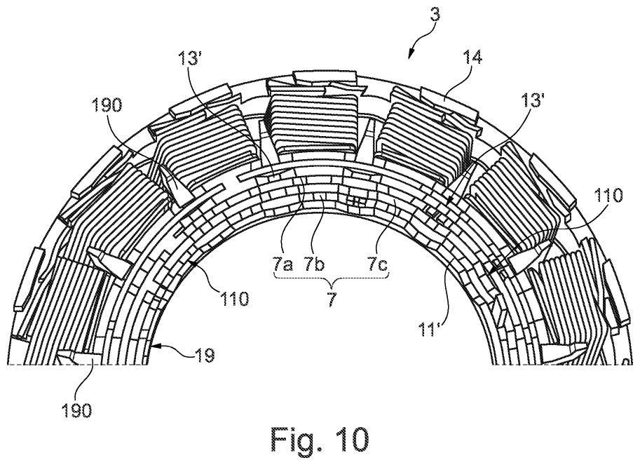

According to a second embodiment shown in FIGS. 9 and 10, the stator 3 comprises first connection frames, respectively denoted 7a, 7b and 7c, disposed on the inner part 31b of the stator body 31 and configured to connect a first end of the coils 33 according to the electrical diagram of FIG. 4 (parallel connection of the various coils 33 associated with a phase u, v, w). The first connection frames 7 are also configured to allow the electrical connections towards the outside of the stator 3, particularly for powering the various phases u, v, w, for example, via additional connectors 17. The first connection frames 7 have, for example, a similar configuration to the second connection frames 9 described in the first embodiment, i.e., disposed concentrically relative to each other and separated by non-electrically conductive walls 11′. The non-electrically conductive walls 11′ also comprise material recesses 110 disposed opposite each other and the first connection frames 7 comprise connectors 13′ axially extending opposite the material recesses 110 in order to allow connection to the first end of the coil 33 disposed opposite the material recesses 110.

In addition, the first connection frames 7 and the non-electrically conductive walls 11′ can be disposed on a module 19 configured to be fixed to the stator body 31. The module 19 is, for example, made of plastic and includes radial tabs 190 on its periphery, said radial tabs 190 being configured to be positioned between the teeth 35 of the stator body 31 to ensure that the module 19 is fixed to the stator body 31. The non-electrically conductive walls 11′ can be integrally formed with the module 19 and the first connection frames 7 are assembled on the module 19. The first connection frames 7 are positioned, for example, in slots provided between the non-electrically conductive walls 11′.

The stator 3 also comprises a second connection frame 9 (shown in FIG. 9) disposed on the outer part 31a of the stator body 31 and configured to connect the second end of the coils 33 of the various phases u, v, w to each other in order to form the star-shaped connection. The second connection frame 9 comprises, for example, five portions each connecting three coils 33 respectively associated with the three phases u, v, w. Alternatively, these connections can be made via one or more second connection frame(s) 9 forming a complete ring, to which some or all the coils are connected depending on the desired electrical diagram. Preferably, the three coils 33 respectively associated with the three phases u, v, w can be disposed adjacently on the stator body 31. The second connection frame 9 is disposed, for example, on an electrical insulating element 14 made of plastic material, which can be overmolded onto the stator body 31.

The one or more first 7 and second 9 connection frame(s) are made of metal, for example, aluminum, brass, copper or iron.

As in the first embodiment, the teeth 35 of the stator body 31 can be separate teeth, as shown in FIG. 3.

According to a third embodiment, not shown, the stator 3 only comprises first connection frames 7 disposed on the inner part 31b of the stator 3 and configured to provide all the electrical connections between the coils 33. The first connection frames 7 can be disposed on a module, such as the module 19 described above.

The present invention also relates to an electric motor 1 comprising a stator 3 as described according to one of the preceding embodiments. The electric motor 1 also comprises a rotor 5 (shown in FIGS. 1 and 9) configured to be positioned inside the stator 3, i.e., in the centre of the stator body 31 and the coils 33. The electric motor 1 is, for example, a three-phase brushless electric motor and comprises, for example, 10 or 14 poles (in the case of an electric motor 1 with 15 coils), but other types of electric motors 1 with, in particular, a different number of poles also can be used. The poles are produced, for example, using permanent magnets disposed on the rotor 5.

The present invention also relates to a method for manufacturing a stator 3 comprising a stator body 31 comprising a plurality of teeth 33 extending between an outer part 31a and an inner part 31b of the stator 3, for example, a stator 3 according to the first embodiment described above.

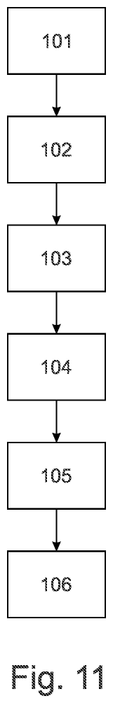

FIG. 11 shows a flowchart of the steps of the method for manufacturing a stator 3 according to the first embodiment shown in FIGS. 1 and 6, in which the teeth 35 are integrally formed with the stator body 31.

The first step 101 relates to positioning the electrical insulating element 14 on the stator body 31. The electrical insulating element 14 is, for example, made of plastic and is overmolded onto the stator body 31. In addition, the electrical insulating element 14 comprises the non-electrically conductive walls 11.

The second step 102 relates to positioning the first 7 and second 9 connection frames on the electrical insulating element 14. The first connection frames 7 are positioned on the outer part 31a of the stator body 31 and the second connection frame 9 is positioned on the inner part 31b of the stator body 31. The fixing frames are retained on the electrical insulating element 14 by positive connection or by stress, whereby the connection frame can be subjected to plastic deformation by retention pads disposed on the electrical insulating element 14.

The third step 103 is an optional step and relates to positioning the first end of the coil 33 in a retention pad 15 configured to retain the end of the coil 33 in position when the coil is wound. The retention pad 15 can be formed on the electrical insulation element 14.

The fourth step 104 relates to winding the coils 33 onto the teeth 35 of the stator body 31. In this embodiment, the teeth 35 are integrally formed with the stator body 31 and the winding is produced starting from the inner side 31b of the stator body 31, as shown in FIGS. 7 and 8. The winding comprises a plurality of coils extending from the inner side 31b to the outer side 31a of the stator body 31. Various layers of turns can be formed, for example, three layers of turns, by winding a new layer of turns over the previous layer. The turns are retained by the edge formed by the end of the teeth 35, which have a T-shaped cross section. In the case of three layers of turns, the winding ends on the outer side 31a of the stator body 31.

According to alternative embodiments, the winding can be produced starting from the outer side. In addition, the winding can comprise a different number of layers of turns other than three. Preferably, the winding is produced so as to make maximum use of the space available around the teeth 35, while allowing the windings of adjacent coils 33 to be produced. For example, the winding is produced by a robot configured to wind the turns around the teeth 35. The windings around the various teeth 35 are, for example, produced one after the other, with the windings all being identical.

The fifth step 105 relates to the connections between the ends of the coils 33 and the first connection frame 7, on the one hand, and between the ends of the coils 33 and the second connection frames 9, on the other hand. The connection is, for example, made by welding or via connectors disposed on the connection frames 7, 9 and configured to retain the winding wire and to provide the electrical connection between the winding wire and the connection frames 7, 9, or by any other means known to a person skilled in the art.

The sixth step 106 is an optional step and relates to the removal of the retention pad 15 used in step 103 when this retention pad 15 is a temporary and detachable pad.

The order of the steps can differ from the order shown, for example, step 106 can be carried out before step 105.

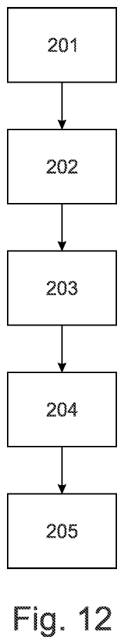

FIG. 12 shows a flowchart of the steps of the method for manufacturing a stator as described above according to the second embodiment shown in FIGS. 9 and 10.

The first step 201 relates to positioning the electrical insulating element 14 on the stator body 31. The electrical insulating element 14 is, for example, made of plastic and is overmolded onto the stator body 31. In this case, the electrical insulating element 14 extends over the outer part 31a of the stator body 31.

The second step 202 relates to winding the coils onto the teeth of the stator body 31. In this embodiment, the winding is produced starting from the inner side of the stator. The winding comprises a plurality of coils extending between the two ends of the tooth. Various layers of turns can be formed, for example, three layers of turns, by winding a new layer of turns over the previous layer. The turns are retained by the edge formed by the end of the teeth 35, which have a T-shaped cross-section. In the case of three layers of turns, the winding ends on the inner side 31b of the stator body 31. Alternatively, the winding can end at other locations.

In addition, the winding can comprise a different number of layers of turns other than three. Preferably, the winding is produced so as to make maximum use of the available space around the teeth 35. For example, the winding is produced by a robot configured to wind the turns around the teeth. The windings are all identical. Retention pads, which may or may not be detachable, can be provided on the electrical insulating element 14 to retain the end of the winding wire.

The third step 203 relates to positioning the second connection frame 9 on the electrical insulating element 14 in the vicinity of the external part 31a of the stator body 31.

The fourth step 204 relates to positioning the module 19 comprising the first connection frames on the stator body 31. Positioning is completed by inserting the radial tabs 190 of the module 19 between the coils 33.

The fifth step 205 relates to the connections between the ends of the coils 33 and the connection frames 7, 9. The connection is made, for example, by welding or via connectors disposed on the connection frames 7, 9 and configured to retain the winding wire and to provide the electrical connection between the connection frames 7, 9 and the winding wire or by any other means known to a person skilled in the art.

The order of the steps can differ from the order shown.

For both embodiments, the stator 3 can comprise separate teeth, as shown in FIG. 3. In this case, the coils 33 are wound on the teeth 35 first and then the teeth 35 are disposed on the stator body 31. The other steps can be similar to the steps described above.

Thus, the arrangement of the connection frames on both the inner side 31a and the outer side 31b of the stator body 31, and therefore of the stator 3, allows an electric motor 1 to be obtained that is axially and radially compact, which allows it to be easily integrated in electric bicycles, in particular. Moreover, manufacturing of such electric motors remains simple and therefore allows large-scale manufacturing.

What is claimed is:

1. Stator for an electric motor comprising:
a stator body comprising a plurality of teeth extending between an outer part and an inner part of the stator body;
a plurality of coils configured to be respectively wound around the plurality of teeth between the outer part and the inner part of the stator body;
characterized in that the stator also comprises:
at least one first connection frame disposed on the inner part of the stator body and configured to provide electrical connections between the coils.

2. Stator according to claim 1, wherein the stator also comprises:
at least one second connection frame disposed on the outer part of the stator body and configured to provide electrical connections between the coils in addition to the at least one first connection frame.

3. Stator according to claim 1, wherein the teeth of the stator are separate detachable teeth.

4. Stator according to claim 1, wherein the one or more first connection frame(s) and/or second connection frame(s) is/are configured to connect the coils using a standard winding, in which the coils of one phase (u, v, w) are connected parallel with each other using a full pitch winding.

5. Stator according to claim 1, wherein the one or more first connection frame(s) and/or second connection frame(s) is/are configured to connect some coils in series using a fractional pitch winding.

6. Stator according to claim 1, wherein the coils are wound by starting winding from the inner part of the stator body.

7. Stator according to claim 1, comprising a first connection frame configured to connect the coils as a star or triangle arrangement and three second connection frames concentrically extending over the outer part of the stator body in order to connect the coils of one phase (u, v, w) to each other, with the second connection frames being separated from each other by non-electrically conductive walls.

8. Stator according to claim 1, comprising a second connection frame configured to connect the windings as a star or triangle arrangement and three first connection frames concentrically extending over the inner part of the stator body in order to connect the coils of one phase (u, v, w) to each other, with the first connection frames being separated from each other by non-electrically conductive walls.

9. Stator according to claim 8, wherein the first connection frames are disposed on a module configured to be positioned on the inner part of the stator body.

10. Stator according to claim 1, wherein an electrical insulation element is disposed on the stator body of the stator and wherein said electrical insulation element comprises a winding wire retention pad.

11. Stator according to claim 10, wherein the retention pad is a temporary pad configured to be removed when positioning the at least one first connection frame.

12. Stator according to claim 10, wherein the electrical insulation element is configured to accommodate the one or more first and second connection frame(s).

13. Electric motor comprising a stator according to claim 1, wherein said electric motor is a three-phase brushless motor.

14. Method for manufacturing a stator comprising a stator body comprising a plurality of teeth extending between an outer part and an inner part of the stator body, the method comprising a step of winding a plurality of coils respectively around the plurality of teeth between the outer part part and the inner part of the stator body, characterized in that the winding step is carried out starting from the side of the inner part of the stator and in that the method also comprises a step of positioning a first connection frame on the inner part of the stator body, said first connection frame being configured to provide electrical connections between the coils.
